(19) United States
(12) Patent Application Publication
(10) Pub. No.: US 2010/0075072 A1
(43) Pub. Date: Mar. 25, 2010

(54) DECORATIVE STRUCTURE OF TREE-SHAPED BELLS

(76) Inventor: Tsung-Wei CHEN, Changhua City (TW)

Correspondence Address: Lu & Associates, P.C., P.O. Box 1380, HAVERTOWN, PA, 19083, US

(21) Appl. No.: 12/237,485

(22) Filed: Sep. 25, 2008

(51) Int. Cl. G09F 19/00

(52) U.S. Cl. 428/7

(57) ABSTRACT

A decoration structure of tree-shaped bells includes a base, an upright pole, a plurality of sleeves, and a plurality of staggered arranged branching bell strings assembling on the upright pole. The sleeves have different lengths configured for spacing the bell strings to present as a distinctive levels in visual effect. The bell strings have different sizes and arranged in staggered directions to construct a special tree-shaped bell decoration and replace a traditional decoration of simulated Christmas tree. This decorative structure of tree-shaped bells not only has unique and novel design but also presents a happy festival atmosphere.

### BACKGROUND

The present invention relates to a decorative structure, especially to a decorative structure of tree-shaped bells.

In Christmastime, various bells or decorative Christmas trees are decorated in rooms of companies, shops or houses to construct a happy festival atmosphere. The decoration of Christmas trees is the best example. A real Christmas tree is usually inconvenient to be placed at some places due to the spatial restriction. The real Christmas tree not only occupy space but also produce environmental problems. Subsequently, these real Christmas trees are replaced by some artificial Christmas trees, and these artificial Christmas trees have the following advantages: may not produce environmental problems by cutting down large numbers of trees; can be reused to bring practical economic benefits. Additionally, the artificial Christmas trees can be manufactured in different sizes in order to place on tables or counters without restricting by the space. The small sized Christmas trees can also produce happy festival atmosphere by being placed at will.

However, the artificial Christmas tree is made according to the shape of the real Christmas tree, and the artificial Christmas tree is a shrunken view from a normal Christmas tree. The artificial Christmas tree is not an eye-catcher for producing a special happy festival atmosphere. In marketing, the artificial Christmas trees produced by different manufactures are generally the same. Therefore, the character of the products cannot be effectively embodied.

Inventers are full of experience and technique on Christmas decorations, and have been researching on the bell decorations in recent years with yielding substantial results. According to the problems of the marketing of the artificial Christmas trees, the inventers combine the bell. decoration with the Christmas tree decorations to present the character of the products in a happy festival atmosphere, and therefore intensifying market competition.

### BRIEF SUMMARY

The present invention relates to a decorative structure of tree-shaped bells, in order to innovate from a decoration of traditional simulated Christmas tree. A tree-shaped bell decoration is designed from an idea of the bells combined with the structure of the Christmas tree. The tree-shaped bell decoration has special configuration in visual effect and presents a happy festival atmosphere.

The decoration structure of tree-shaped bells includes a base, an upright pole, a plurality of sleeves, and a plurality of staggered arranged branching bell strings assembling on the upright pole. The sleeves have different lengths configured for spacing the bell strings to present as a distinctive levels in visual effect. The bell strings have different sizes and arranged in staggered directions to construct a special tree-shaped bell decoration.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an isometric view of an exemplary embodiment of the invention;

FIG. 2 is an exploded, isometric view of the exemplary embodiment of the invention;

FIG. 3 is a partial, exploded view of the exemplary embodiment of the invention; and

FIG. 4 is a structural, schematic view of the exemplary embodiment of the invention.

### DETAILED DESCRIPTION

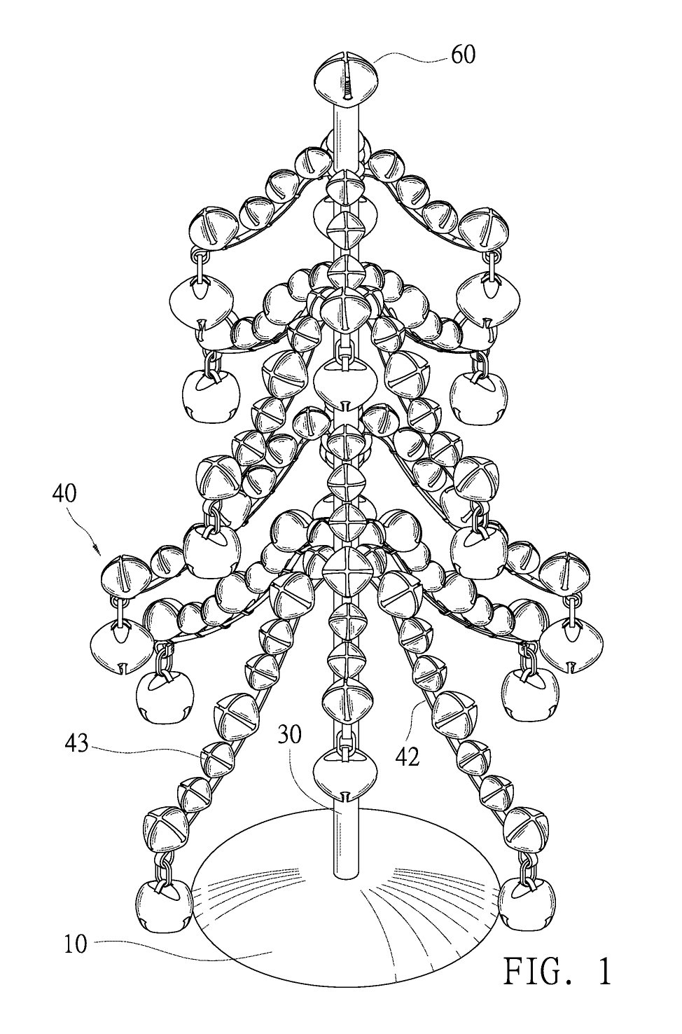

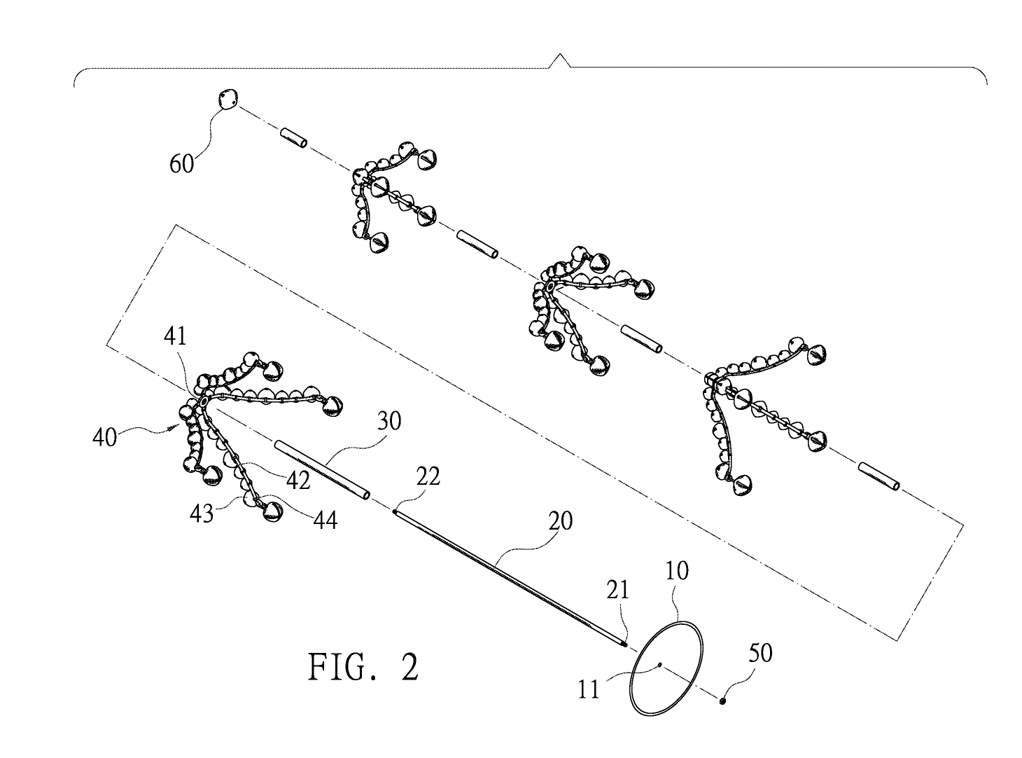

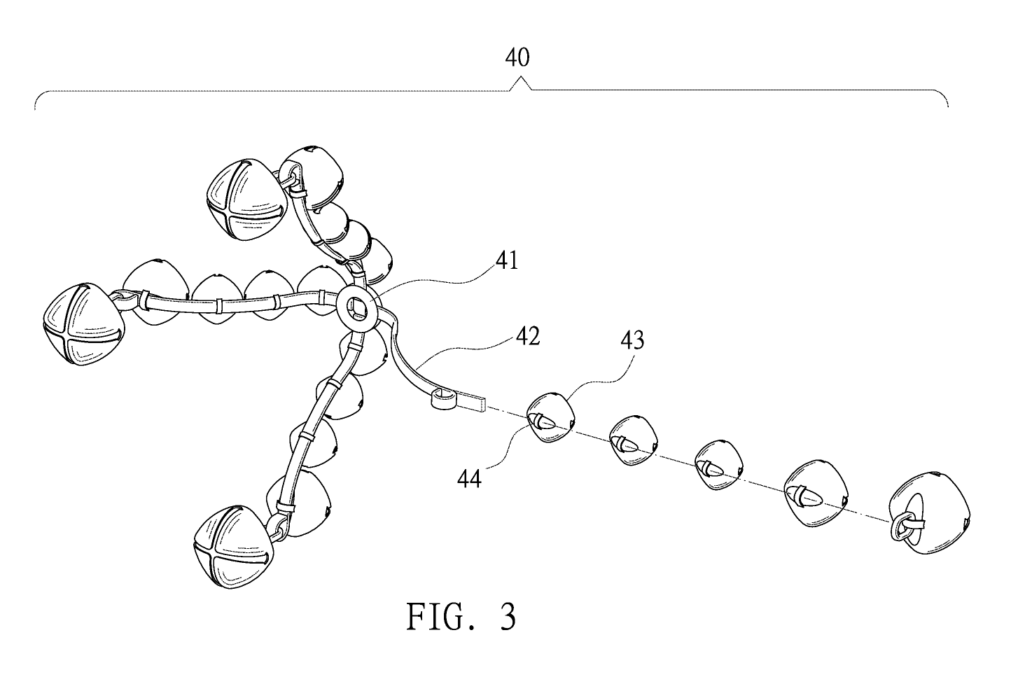

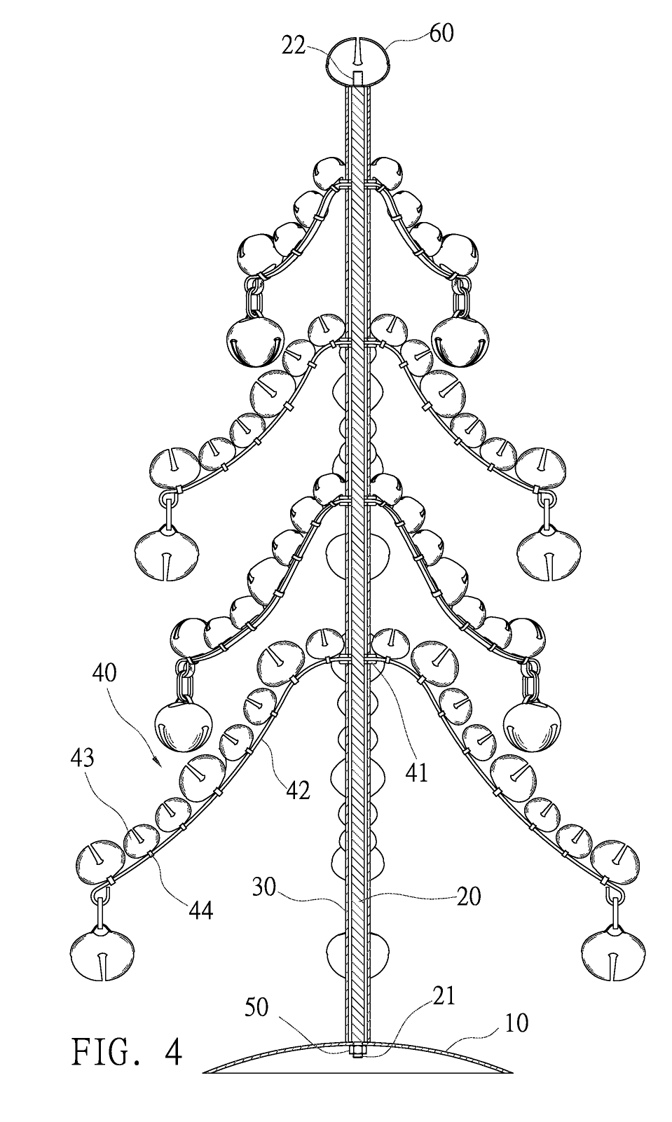

A assembled, schematic view is shown in FIG. 1, an exploded, isometric view is shown in FIG. 2, a partial exploded view is shown in FIG. 3 and a structural, schematic view is shown in FIG. 4. Referring through FIG. 1 to FIG. 4, an exemplary embodiment of the invention are shown, the embodiment includes a base 10, an upright pole 20, a predetermined number of sleeves 30, a predetermined number of bell strings 40, a cap-shaped lower fastener 50 and an upper fastener 60. The upright pole 20 has threads 21, 22 on opposite ends thereof. The lower thread 21 of the upright pole 20 is engaged with the cap-shaped lower fastener 50 through a central hole 11 defined in the base 10, so that the upright pole 20 is firmly fixed on the base 10. The upright pole 20 can receive the sleeves 30 and the bell strings 40 thereon with interval arrangement. The sleeves 30 are the spacing between each two bell strings 40 in order to form a structure with different levels. The upper fastener 60 is screwed on the top thread 22 of the upright pole 20. In the embodiment, the upper fastener 60 is configured to a bell shape.

In order to construct a tree-shaped structure, the bell string 40 is made to a branching style. The bell string 40 includes a central ring 41, a predetermined number of limbs 42 radially and laterally extending from the central ring 41, and a predetermined number of bells 43. The limbs 42 extend through an ear 44 of each bell 43. Each distal end of the limb 42 is bent to a closed end. The bell string 40 is configured to stagger arrangement with branches and leaves. Alternatively, the bell string 40 can be made in different sizes. When the bell string 40 with different sizes are assembled on the upright pole 20, the size of the bell strings 40 from up to down is increased, and the limbs 42 and the bells 43 of each bell string 40 are staggered arranged. Due to the extension of the bell strings 40 reduced from the bottom up, the similarly Christmas-tree-shaped decoration configuration has distinctive staggered levels, and special visual effect therefore being presented.

As disclosed above, in the embodiment, the tree-shaped bell decoration includes the bell strings 40 strung with branching limbs 42 and the bells 43, the sleeves 30, the upright pole 20 and the base 10. The bell strings 40 and the sleeves 30 are sequently assembled on the upright pole 20 which is fixed on the base 10. The design idea of bell decoration is novelly introduced to the decoration of the Christmas tree to replace a traditional decoration of the simulated Christmas tree. The new bell decoration has following advantages: producing a special happy festival atmosphere in the season of Christmas; a distinctive different can be embodied compared with the present decoration of simulated Christmas tree; being an eye-catcher from the consumers to simulate their purchasing desire; enhancing the market competitiveness; and finally full of industrial utility value.

In summary, the embodiment of the invention relates to a tree-shaped bell decoration, the structure of the bell decoration includes a group of predetermined number of branching bell strings assembling on an upright pole of a base. Each bell string is properly spaced by a plurality of sleeves with different lengths in order to present distinctive staggered levels in visual effect. Additionally, the bell strings have different sizes and different branching directions to present a tree-shaped bell decoration to replace a traditional decoration of simulated Christmas tree. The bell decoration has unique and novel design in visual effect, and produces a special happy festival atmosphere.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A decorative structure of tree-shaped bells comprising:
a base, a hole defined in a central of the base;
an upright pole extending through the hole and firmly fixed on the base, the upright pole having thread on two opposite ends thereof,
a plurality of sleeves assembling on the upright pole;
a plurality of bell strings, each bell string comprising a central ring, a plurality of limbs radiately extending from the central ring, and a predetermined number of bells being strung on the limbs, the limbs and the bells configured to a branching arrangement, the bell strings assembled on the upright pole with the upright pole extending through the central ring, and the central rings being spaced by the sleeves;
a lower fastener configured for engaging with the thread on a lower end of the upright pole to fix the upright pole to the base; and
an upper fastener configured for engaging with the thread on an upper end of the upright pole to fix the sleeves and the bell strings to the upright pole.

2. The decorative structure of tree-shaped bells as claimed in claim 1, wherein the sleeves have different lengths configuring for spacing the bell strings with different intervals.

3. The decorative structure of tree-shaped bells as claimed in claim 1, wherein the bell strings have different sizes, so that the structure is configured in a tree-shaped appearance with different visual levels when the bell strings assembling on the upright pole.

4. The decorative structure of tree-shaped bells as claimed in claim 1, wherein the lower fastener is a screw cap.

5. The decorative structure of tree-shaped bells as claimed in claim 1, wherein the upper fastener is a bell with thread.
